(19) United States
(12) Patent Application Publication
(10) Pub. No.: US 2019/0161657 A1
(43) Pub. Date: May 30, 2019

(54) METHOD FOR RECOVERING ABRASIVE ELEMENTS CONTAINED IN A RESIN-BONDED MATERIAL AND USE OF SAID ELEMENTS THUS RECOVERED

(71) Applicants: EXTRACTHIVE, Saint-Genies-De-Comolas (FR); EURALOX, Luynes (FR)

(72) Inventors: Frédéric GOETTMANN, Courthezon (FR); Quentin RICOUX, ORANGE (FR)

(21) Appl. No.: 16/201,340

(22) Filed: Nov. 27, 2018

(30) Foreign Application Priority Data
Nov. 28, 2017 (FR) 1761260

(51) Int. Cl. C09K 3/14; C01F 7/46; C04B 35/10; C04B 35/622; B02C 23/10

(52) U.S. Cl. CPC C09K 3/1409; C01F 7/46; C04B 35/10; C04B 2235/3218; B02C 23/10; C04B 2235/3217; C04B 2235/322; C04B 35/62204

(57) ABSTRACT

A process for recovery of all or some abrasive elements contained in an abrasive material in which the abrasive elements are dispersed in a resin with at least one phenolic hydroxyl group, the process including steps of: a) bringing the abrasive material into contact with an aqueous nitric solution (S₁), whereby an aqueous nitric solution (S₂) is obtained containing abrasive elements and residue derived from degradation of the resin; then (b) separating the abrasive elements from the aqueous nitric solution (S₂) obtained after step (a). The use of abrasive elements thus recovered particularly to prepare agglomerated abrasives or coated abrasives.

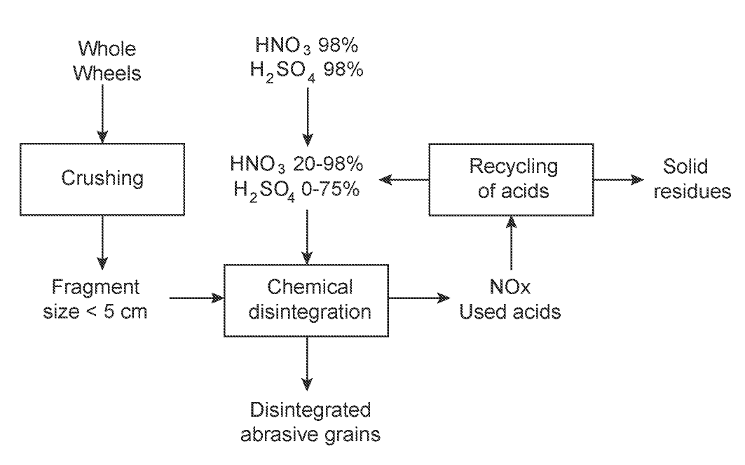

### TECHNICAL DOMAIN

This invention relates to the field of recycling abrasive materials comprising abrasive elements and a resin, and particularly agglomerated abrasive materials and coated abrasive materials.

More particularly, this invention discloses a method for recovering abrasive elements from an abrasive material comprising said abrasive elements and a resin with at least one phenolic hydroxyl group.

This invention also relates to the use of abrasive elements thus recovered particularly to prepare new abrasive materials comprising abrasive elements and a resin.

### STATE Of PRIOR ART

The fabrication and the use of abrasives with resin binders such as abrasive wheels, cutting wheels or coated abrasives lead to the production of waste such as fabrication waste, cutting waste and used wheels. These are composed of minerals that act as abrasive fillers bonded by resins, all being applied or coated on supports and/or reinforced by mineral fibres or metal cores. Abrasive fillers can be brown, white and violet corundums, bauxite and sintered alumina or extruded alumina grains.

Fabrication waste from abrasive wheels alone amounts to of the order of 25,000 tonnes annually. Abrasive fillers make the largest contribution to the value of wheels because their value in the new condition varies from 500 € per tonne for brown corundums to 40,000 € per tonne for sol-gel grains. Therefore the fabrication scrap recycling market alone can be estimated at about 12.5 million Euros per year. Apart from the economic aspect, picking up and recycling of waste abrasive wheels has also become an important challenge for producers in terms of regulations since the “producer's extended liability” was set up and commercially since the final destination of wheels at the end of their life becomes a controlling criterion for obtaining new contracts.

The different recycling channels envisaged in the past make use of mechanical (grinding), thermal (pyrolysis) and/or biological (bioleaching) treatment processes.

Mechanical processes consist of grinding the wheels so as to obtain agglomerates composed of abrasive minerals coated with resin. This approach enables reuse of abrasives in lower added value applications, for example such as abrasives for sanding processes or as a raw material for the core of grinding wheels during fabrication of other abrasive materials [1]. Another example of down-cycling is reuse of the inactive part in grinding a first abrasive material for fabrication of the non-abrasive part of a new abrasive material [2] or reuse of the abrasive part of a first abrasive material for fabrication of the abrasive part of a new abrasive material [3].

Thermal processes used for recycling of abrasive wheels consist of thermally oxidising the resin binding the abrasive grains. The thermal approach requires that compromises are found to obtain sufficiently high temperatures to achieve degradation of the resin, but at which the fillers are not degraded. Temperatures of 600° C. are generally recommended, leading to treatment costs estimated at about 350 €/t. Furthermore, the abrasive grains recovered from such processes are polluted by the presence of coke which prevents reuse for the fabrication of solid or applied abrasives.

Thus, industrialised recycling processes of abrasives with binder resins are very imperfect, such that 90% of all waste will currently end up in landfill or for burial, introducing non-negligible risks of leaching of the resin and contamination of the ground by phenol when phenolic type resins are used as binder.

Therefore the inventors set themselves the objective of proposing an easy-to-use method that can be industrialised and by which abrasive elements can be recovered from an abrasive material containing said abrasive elements in a resin, efficiently and without damaging the elements so that they can be reused afterwards, particularly in new abrasive materials.

### PRESENTATION Of THE INVENTION

This invention solves the technical problems described above and can achieve the stated purpose of the inventors.

Work done by the inventors has made it possible to perfect an industrialisable process for obtaining abrasive elements recovered from abrasive materials containing these elements in a phenol based resin.

More particularly, the process developed by the inventors includes an attack on the phenol-based resin part of the abrasive materials using nitric acid. Without wishing to be bound by any theory, the inventors believe that nitric acid oxidises the phenol based resin and leads to the formation of very unstable nitroso functions that decompose, generating nitrogen oxides and radicals that are also unstable. In the case of bakelite and, in general, of polyphenolic compounds the nitration reaction can be shown schematically as follows:

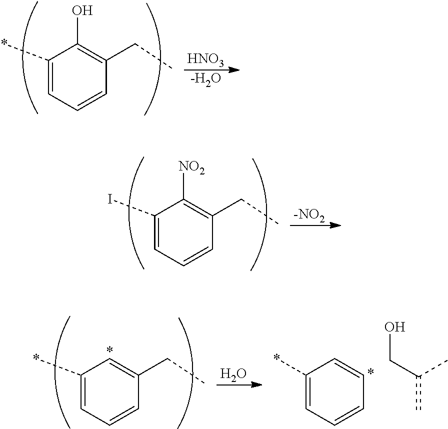

This reaction leads firstly to oxidation and depolymerisation of the resin, and secondly reduction of nitric acid.

Note that the quality of abrasive elements obtained following the recovery process according to the invention is such that they can be used to prepare new abrasive materials with properties comparable to properties of abrasive materials prepared from new abrasive elements.

More particularly, the present invention relates to a process for recovery of all or some abrasive elements from an abrasive material in which said abrasive elements are maintained or held in a resin with at least one phenolic hydroxyl group, said process including steps of:

a) bringing said abrasive material into contact with an aqueous nitric solution (S₁), whereby an aqueous nitric solution (S₂) is obtained containing abrasive elements and residue derived from degradation of said resin; then

b) separating the abrasive elements from the aqueous nitric solution (S₂) obtained subsequent to said step (a).

For the purposes of this invention, “abrasive material” includes agglomerated abrasive materials and also coated (or applied) abrasive materials.

“Agglomerated abrasive material” or “agglomerated abrasive” means a porous or non-porous material comprising a mix of solid abrasive elements or grains and a binder or agglomerant in which the grains are uniformly distributed and held in place.

“Coated abrasive material” or “coated abrasive” refers to a material comprising a support on which there is a layer of abrasive elements or grains fixed to the support by means of a binder or agglomerant. The support in such an abrasive material may be paper, fabric, a paper-fabric combination, a fibre, a non-woven material or meshes. More particularly, a coated abrasive material is composed of a support on which there is a layer of abrasive elements or grains fixed to the support by two layers of binder. A first binder layer is used to deposit abrasive elements or grains on the support, providing basic adhesion of these elements or grains and the second binder layer anchors them. The chemical nature of the binders used for the first layer and for the second layer can be identical or different.

The abrasive material to which the process according to this invention is applied can have any shape and size. In particular, the size of this material can vary from a few millimetres to several metres. Typically, this abrasive material is chosen from among miniature bearing ring grinding wheels, wheels on spindles, wheels for bench grinders, foundry grinding wheels, cutting wheels, wood defibration wheels, glass paper, abrasive disks such as abrasive disks for sanders and abrasive bands.

In the context of this invention, the abrasive material binder or agglomerant to which the process according to this invention is applied is an organic (co)polymer compound i.e. a resin. The term “resinoid agglomerated abrasive” is used in this case and when the abrasive material is of the agglomerated abrasive type. In the case of a coated abrasive material, at least one of the two binders is a resin, and advantageously both binders are resins.

Note that the resin of the abrasive material to which the process according to the invention is applied is a resin with at least one phenolic hydroxyl group. In the case of a coated abrasive material, at least one of the two binders is a resin with at least one phenolic hydroxyl group and advantageously both binders are resins with at least one phenolic hydroxyl group.

Any natural or synthetic resin with at least one phenolic hydroxyl group, i.e. any natural or synthetic resin based on possibly substituted phenol can be used in the context of this invention.

Advantageously, the resin of the abrasive material to which the process according to the invention is applied is a phenol-formaldehyde resin, a cresol-formaldehyde resin or a xylenol-formaldehyde resin. More particularly, the resin of the abrasive material to which the process according to the invention is applied is a phenol-formaldehyde resin, i.e. a phenoplast.

The abrasive elements to be recovered after implementation of the process according to the invention are in the form of grains. The median size of these grains is between 100 μm and 5 mm and particularly between 150 μm and 4 mm. All abrasive elements normally used for abrasive materials as defined above can be used with this invention.

The abrasive elements to be recovered after implementation of the process according to the invention can be natural abrasives such as diamond, garnet, natural corundum or emery.

As a reminder, natural corundum is a crystallised alumina with formula Al₂O₃ also denoted α-Al₂O₃ comprising between 6 and 10% of impurities such as iron, titanium, chromium, manganese, nickel, vanadium and/or silicon. Emery is composed of crystallised alumina (35 to 70%), silica and iron oxide.

Abrasive elements that are to be recovered after implementation of the process according to the invention can be synthetic abrasives such as alumina (or aluminium oxide), zirconia (or zirconium dioxide or zirconium(IV) oxide), brown corundums (or 95% alumina), white corundums (or 99% alumina), pink corundums, violet corundums, monocrystalline aluminas, zirconia aluminas, silicon carbide and sintered bauxite.

As a reminder, brown corundum is obtained by treating bauxite (ore composed particularly of alumina, hematite and titanium) at a temperature of more than 2000° C. in an electric arc furnace in the presence of casting agents and a coke type reduction agent. White corundum is obtained using the same process as the process to obtain brown corundum but using chemically produced pure amorphous alumina as the initial material. Pink and violet corundums are obtained using the same process as the process for obtaining white corundum but adding chromium oxide to the alumina, the only difference between pink and violet corundums being the content of chromium oxide. Note that all corundums are crystalline. Zirconia aluminas are prepared by melting alumina and zirconia in variable proportions. The silicon carbide used in the context of this invention is the crystalline form obtained in an electric furnace by reduction of silica by carbon in the form of sprayed petroleum coke, at a temperature of about 2200° C. (2200° C.±100° C.). Sintered bauxite has a brick red colour due to its high content of hematite (>10%) and is opaque.

The abrasive elements that are to be recovered after implementation of the process according to the invention can be a mixture of at least two natural abrasives as defined above, at least two synthetic abrasives as defined above or a mix of at least one natural abrasive as defined above and at least one synthetic abrasive as defined above.

Advantageously, the abrasive elements to be recovered after implementation of the process according to the invention are chosen from the group consisting of alumina (or aluminium oxide), brown corundums, white corundums, violet corundums, zirconia (or zirconium dioxide or zirconium(IV) oxide), diamond, silicon carbide, sintered bauxite and mixtures thereof.

As explained above, step (a) in the method according to this invention uses a particular solution for the treatment of resin with at least one phenolic hydroxyl group. This consists of a nitric acid solution (S₁).

Advantageously, the aqueous nitric solution (S₁) used in step (a) of the method according to the invention contains at least 20% by mass of nitric acid relative to the total mass of said aqueous nitric solution (S₁).

In a first embodiment, the aqueous nitric solution (S₁) does not contain any acid other than nitric acid. In this first embodiment, the content of nitric acid in the aqueous nitric solution (S₁) is advantageously greater than or equal to 30% by mass relative to the total mass of said aqueous nitric solution (S₁). In some implementations of this first embodiment, nitric acid in the aqueous nitric solution (S₁) can be greater than or equal to 40% by mass, and notably greater than or equal to 50% by mass, and particularly greater than or equal to 60% by mass of the total mass of said aqueous nitric solution (S₁).

In a second embodiment, the aqueous nitric solution (S₁) can contain at least one other acid chosen from the group consisting of hydrochloric acid and sulphuric acid, in addition to nitric acid. Advantageously, this other acid is sulphuric acid. More particularly, when sulphuric acid is present in the aqueous nitric solution (S₁) in addition to nitric acid, this solution contains at least 30% by mass of sulphuric acid relative to the total mass of said aqueous nitric solution (S₁).

Regardless of the embodiment, the one skilled in the art knows different ways of preparing such an aqueous nitric solution (S₁) either by diluting existing commercial compositions, or be preparing them extemporaneously.

Generally, during step (a) of the process according to this invention, when the abrasive material to be treated is of the agglomerated type, the “mass of nitric acid”/“mass of abrasive material” ratio is greater than or equal to 1, notably it is greater than or equal to 1.1 and in particular is greater than or equal to 1.2. When the abrasive material to be treated is of the coated type, the “mass of nitric acid”/“mass of abrasive material” ratio is less than 1, particular it is less than or equal to 0.85 and particular is less than or equal to 0.7.

Advantageously, during step (a) in the method according to this invention, contact is made at a temperature comprised between ambient temperature and 150° C. Ambient temperature means a temperature between 17° C. and 27° C.

More particularly, when the contact temperature is more than ambient temperature, step (a) in the process according to this invention may comprise the following successive sub-steps of:

a₁) preparing an aqueous nitric solution (S₁) as defined above and with a temperature T higher than ambient temperature and less than or equal to 150° C.; and

a₂) bringing the abrasive material into contact with the solution prepared in step (a₁), said contact being made at said temperature T.

As an alternative, when the contact temperature is more than ambient temperature, step (a) in the process according to this invention may comprise the following successive sub-steps of:

a₁′) bringing the abrasive material into contact with the aqueous nitric solution (S₁) as previously defined; and

a₂′) bringing the solution prepared in step (a₁) (i.e. the aqueous nitric solution (S1) in which the abrasive material is located) to a temperature T greater than ambient temperature and less than or equal to 150° C.

The solution during step (a₁) or (a₂′) is brought to temperature T called the “treatment temperature”. This is supposed to be reached when the measurement of the temperature of the solution during step (a₁) or (a₂′) made by means of an adapted measurement means, for example a thermometer, gives a value close to the desired temperature for 15 minutes, within measurement uncertainties.

In the process according to the invention, the contact made between the abrasive material and the aqueous nitric solution (S₁) can be made using any means capable of making a uniform or non-uniform treatment of the abrasive material by aqueous nitric solution (S₁) as defined above.

Making this contact typically consists of dipping and holding the aqueous material in the aqueous nitric solution (S₁). When contact is made, the aqueous nitric solution (S₁) can be mechanically shaken, by ultrasound or by circulation of the aqueous nitric solution. To achieve this, a mixer, stirrer, ultrasound system, homogeniser or recirculation pump can be used, in order to maintain homogeneity of the aqueous nitric solution (S₁) and avoid deposition or retention of products resulting from degradation of the resin at the surface of the abrasive material.

In the method according to this invention, making contact between the abrasive material and the aqueous nitric solution (S₁) has a duration greater than or equal to 15 minutes, notably greater than or equal to 30 minutes, and particularly greater than or equal to 1 hour. Note that the one skilled in the art will find it easy to determine the optimum contact time visually. Depending on the appearance of the aqueous nitric solution (S₁) i.e. presence of abrasive material or abrasive elements dispersed in this solution, the one skilled in the art will know if contact can be stopped or otherwise needs to be continued.

In the context of the process according to the invention and more particularly during the step in which contact is made, it may be necessary to top up the aqueous nitric solution (S₁) continuously with water such as ultra-pure or demineralised water or nitric acid, to compensate for evaporation induced by the treatment temperature T and reduction of nitric acid to nitrogen oxides. Furthermore, any device to maintain a constant volume of aqueous nitric solution (S₁) in particular by the condensation of vapours (reflux set up) can advantageously be used.

Furthermore, in the context of the process according to the invention and more particularly during the step to make contact, it is necessary to maintain the temperature of the aqueous nitric solution (S₁) at the treatment temperature T as defined above. To achieve this, contact may be made in the presence of a heating element and temperature regulation means capable of keeping said heating element at a set temperature, chosen such that when said set temperature is obtained and maintained, the temperature of the aqueous nitric solution (S₁) is maintained at the treatment temperature T.

At the end of step (a) of the process according to the invention, an aqueous nitric solution (S₂) is obtained containing abrasive elements and residues originating from degradation of said resin. The aqueous nitric solution (S₂) can be considered to be a used acid solution because there is some remaining acidity. Advantageously, the aqueous nitric solution (S₂) comprises nitrogen oxides, organic compounds originating from the degradation of resins and mineral compounds originating from the degradation of reinforcement elements that may be present in the abrasive material to be treated, in addition to the nitric acid and possibly the at least one other acid such as sulphuric acid.

Any technique that can separate abrasive elements obtained after step (a) of the solution (S₂) can be used during step (b) of the process according to the invention. Advantageously, the separation step during step (b) comprises one or several steps of solid/liquid separation that may be identical or different, such as settlement, filtration and/or centrifuging.

No particular special treatment is applied to the abrasive material before the process according to this invention is implemented and therefore before step (a) of this process. As an alternative, a grinding or crushing type treatment can be carried out on the abrasive material to which the process according to the invention is applied before the process is implemented and therefore before step (a) of this process. Such a treatment can reduce a massive abrasive material into smaller fragments, typically smaller than or equal to 10 cm and notably smaller than or equal to 5 cm, so as to facilitate attack of this material by nitric acid.

After implementation of the process according to this invention and therefore after step (b) of this process, abrasive elements separated from the aqueous nitric solution (S₂) can be recycled, particularly to prepare new abrasive materials. Similarly, an additional recycling step can be made on the nitric acid solution (S₂) obtained after step (b) i.e. the nitric acid solution (S₂) as previously defined and without abrasive elements.

Any technique known by the one skilled in the art to recycle a solution containing used acids, nitrogen oxides, organic compounds derived from the degradation of resins and inorganic compounds derived from the degradation of reinforcing materials can be used in the context of this invention. In particular, this recycling makes it possible to regenerate acids initially contained in the aqueous nitric solution (S₁) and to precipitate organic compounds and inorganic compounds in the form of solid residues. Such recycling includes one or several identical or different steps such as precipitation, oxidation, absorption or distillation.

One particular example of the process used to recycle the nitric acid solution (S₂) obtained after step (b) consists of (i) a precipitation (for example by the addition of sulphate), (ii) oxidation of residual organic compounds at 150° C. and (iii) distillation de nitric acid in sulphuric acid, the nitrogen oxides being absorbed in columns to recreate 50% nitric acid before being reconcentrated by distillation.

This invention also relates to a process for preparation of an agglomerated abrasive material. Note that the binder of such an agglomerated abrasive can be any binder used in the context of abrasive materials and not exclusively a phenolic type resin. Thus, this binder can be a vitrifiable inorganic agglomerant, a magnesian inorganic agglomerant, a resinoid organic agglomerant and a rubber organic agglomerant. The resin used in a resinoid organic agglomerant can be a thermoplastic resin or a thermosetting resin.

More particularly, this invention relates to a process for preparation of an abrasive material comprising abrasive elements in a binder, said process comprising the following steps of:

i) obtaining abrasive elements following a recovery process such as defined above;

ii) bringing the abrasive elements obtained following step (i) into contact with a binder or a precursor of said binder and mixing the assembly;

iii) possibly applying a heat treatment to the mixture obtained after step

Everything that has been explained above for the process for recovery of abrasive elements is applicable mutatis mutandis to step (i) in the preparation process according to the invention.

After step (i) and before step (ii), one or several washing steps can be carried out on the recovered abrasive elements, particularly so as to eliminate the acid(s) used in solution (S₁) or (S₂). The washing step(s) is (are) typically performed in a polar solvent such as water.

Step (ii) in the process according to the invention consists of mixing the abrasive elements with either a binder, or a precursor of said binder. “Precursor of a binder” means:
a mixture of feldspar, clays and silica for a vitrifiable inorganic agglomerant;
a mixture of magnesium chloride and magnesia for a magnesian inorganic agglomerant;
a mixture of identical or different monomers that can be used to produce a specific resin or rubber by polymerisation for a resinoid organic agglomerant or a rubber organic agglomerant respectively.

Step (iii) is optional for an abrasive material for which the binder is for a magnesian inorganic agglomerant.

On the other hand, step (iii) is a compulsory step to make a chemical transformation of the mixture obtained after step (ii) and leading to the required abrasive material. For example, this step (iii) may consist of exposing the mixture of abrasive elements, feldspar, clays and silica to a temperature between 900° C. and 1300° C., for at least 24 hours. This step (iii) may also consist of vulcanisation at a temperature of the order of 180° C. (180° C. ±10° C.) for abrasive materials based on rubber inorganic agglomerant.

Before step (iii), a pressing step and/or a machining step may be made on the mixture obtained after step (ii). Similarly, a machining step can be carried out on the product obtained after step (iii).

This invention also relates to a process for preparation of a coated abrasive material as defined above.

Any support normally used for coated abrasives can be used in the context of this preparation process according to the invention. Typically, this support is chosen particularly from the group consisting of paper, fabric, a paper-fabric combination, a fibre, a non-woven material and meshes.

Similarly, any binder normally used for coated abrasives can be used in the context of this preparation process according to the invention. Typically, the binder used is chosen from among natural or organic glues such as animal glues derived from skins or tendons and synthetic resins, for example such as urea-formaldehyde resins, phenol-formaldehyde resins, cresol-formaldehyde resins and xylenol-formaldehyde resins.

More particularly, this invention relates to a process for preparation of an abrasive material comprising abrasive elements on a support, said process comprising the following steps of:

i′) obtaining abrasive elements following a recovery process such as defined above;

ii′) depositing abrasive elements obtained following step (i′) on a support with a layer of a first binder;

iii′) applying a layer of a second binder, identical to or different from said first binder, on the support obtained after step (ii′).

Everything that has been explained above for the process for recovery of abrasive elements is applicable mutatis mutandis to step (i′) in the preparation process according to the invention.

After step (i′) and before step (ii′), one or several washing steps can be carried out on the recovered abrasive elements, particularly so as to eliminate the acid(s) used in solution (S₁) or (S₂). The washing step(s) is (are) typically performed in a polar solvent such as water.

The support obtained after step (ii′) is a support on which the abrasive elements adhere to the layer of the first binder. The layer of the second binder applied during step (iii′) can anchor the abrasive elements.

After step (ii′) and/or after step (iii′), a drying step and possibly a heating step may be made on the support obtained.

Other characteristics and advantages of this invention will become clear to the one skilled in the art after reading the non-limitative examples given below for illustrative purposes, with reference to the single appended figure.

### BRIEF DESCRIPTION OF THE DRAWINGS

The single FIGURE shows a diagrammatic representation of the recovery and recycling process according to the present invention.

### DETAILED PRESENTATION OF PARTICULAR EMBODIMENTS

I. Recovery Process According to the Invention.

With reference to the single FIGURE, the recovery process according to the invention applied to recycling of abrasive wheels comprises:

one or several crushing steps, depending on the size of the wheels to be recycled, to obtain fragments smaller than 5 cm;

an oxidation step with nitric acid at temperatures between ambient temperature and 150° C. with an aqueous solution containing 20 to 98% of nitric acid and 0 to 75% of sulphuric acid; and

a recycling step of the solvent in the form of nitrogen oxides and a mixture of used acids that can contain organic compounds (resin degradation products) and inorganic compounds (dissolved inorganic fillers).

II. Examples of the use of a Recovery Process According to the Invention.

Different types of abrasive materials with a phenol-formaldehyde type resin were recycled using this approach. The abrasive fillers of the different tested materials, the operating conditions and the results of these tests are listed in Table 1 below. Note that compositions in this table are given as a percentage by mass.

TABLE 1
Examples of recycled materials, operating conditions and performances.

| | | | | | Loss of mass | |
|---|---|---|---|---|---|---|
| | | | | Solvent | (%) | |
| | | | | composition | Mass of | |
| | Mass of | | | (complement to | recovered | |
| Abrasive | added | Solvent | Reaction | 100% in the form | material M | Depolymerisation |
| material (M) | material M | volume | temperature | of water) | (g) | yield |
| Brown | 10.01 g | 60 mL | 130° C. under | 68% HNO₃ | 33% | 99.9% |
| corundum | | | reflux - 2 h | | 6.71 g | |
| Brown | 10.14 g | 18 mL | 130° C. under | 68% HNO₃ | 27% | 69% |
| corundum | | | reflux - 2 h | | 7.36 g | |
| Brown | 10.01 g | 30 mL | 130° C. under | 68% HNO₃ | 32% | 91% |
| corundum | | | reflux - 2 h | | 6.77 g | |
| Brown | 9.97 g | 46 mL | 130° C. under | 68% HNO₃ | 34% | 99.9% |
| corundum | | | reflux - 2 h | | 6.58 g | |
| Brown | 10.60 g | 60 mL | 130° C. under | 68% HNO₃ | 33% | 99.8% |
| corundum | | | reflux - 5 h | | 7.05 g | |
| Brown | 9.95 g | 60 mL | 130° C. under | 68% HNO₃ | 29% | 99.2% |
| corundum | | | reflux - 2 h | | 7.08 g | |
| Brown | 10.40 g | 55 mL | 130° C. under | 34% HNO₃ | 20% | 40% |
| corundum | | | reflux - 2 h | | 8.29 g | |
| Brown | 10.04 g | 60 mL | 130° C. under | 23% HNO₃ | 28% | 75% |
| corundum | | | reflux - 2 h | 33% H₂SO₄ | 7.27 g | |
| Brown | 972 g | 3500 mL | 90° C. | 68% HNO₃ | 27% | 99.9% |
| corundum | | | | | 710 g | |
| Sintered bauxite | 13.02 g | 53 mL | 130° C. under | 68% HNO₃ | 24% | |
| | | | reflux | | | |
| Mixture of solgel | 515 g | 750 mL | 77° C. | 68% HNO₃ | 15% | 99.9% |
| alumina, | | | | | | |
| alumina balls | | | | | | |
| and violet | | | | | | |
| corundum | | | | | | |
| Sol - gel | 0.98 kg | 1250 mL | 80-85° C. | 68% HNO₃ | 39% | 99.9% |
| alumina | | | | | | |
| Cold-pressed | 9.48 g | 30 mL | 130° C. under | 68% HNO₃ | 11% | 99.93% |
| sol gel | | | reflux | | | |
| alumina | | | | | | |
| Sintered alumina | 14.96 g | 40 mL | 130° C. under | 68% HNO₃ | 33% | |
| | | | reflux | | | |
| Violet corundums | 146 g | 500 mL | 90° C. | 68% HNO₃ | 45% | 99.86% |
| | | | | | 80.6 g | |

III. Comparison of Performances of Products Fabricated from New Grains and Grains Recycled using the Process According to the Invention.

Comparative cutting tests were performed to quantify the impact of recycling on cutting properties of abrasive grains.

Thus, ten cutting disks were fabricated based on brown corundums. Five were put to one side, the other five were “recycled” using the process according to the invention.

The composition of collected/recycled corundum grains were firstly compared with non-recycled grains (Table 2).

The recycled grains were then used to make five disks, using the same method as for the first disks. The ten disks were then used for cutting tests on stainless steel parts, and the results of these tests are given in Table 3 below.

TABLE 2
Composition of brown corundums that have and
have not been recycled

| Name | Original corundum grains | Recycled corundum grains |
|---|---|---|
| Al₂O₃ | 97.6 | 98.0 |
| SiO₂ | 0.49 | 0.31 |
| Fe₂O₃ | 0.20 | 0.16 |
| TiO₂ | 1.60 | 1.48 |
| CaO | 0.05 | 0.00 |
| MgO | 0.00 | 0.00 |
| K₂O | 0.00 | 0.00 |
| Na₂O | 0.00 | 0.00 |
| P₂O₅ | 0.01 | 0.01 |
| Cr₂O₃ | 0.00 | 0.00 |
| MnO | 0.00 | 0.00 |
| ZrO₂ | 0.16 | 0.15 |
| C | 0.18 | 0.07 |
| S | 0.04 | 0.04 |
| LOI | −0.10 | −0.06 |
| sum [% by | 100.00 | 100.00 |
| mass] | | |

TABLE 3
Results of comparative cutting tests

| | | Recycled abrasive |
|---|---|---|
| Disks | New abrasive elements | elements |
| Initial diameter (mm) | 176.88 | 176.76 |
| Final diameter (mm) | 173.73 | 173.88 |
| Wear (mm) | 3.15 | 2.88 |
| Wear area (cm²) | 8.67 | 7.95 |
| Cutting area (cm²) | 3.13 | 3.13 |
| Number of cuts | 20 | 20 |
| Total cut area (cm²) | 62.52 | 62.52 |
| G-Ratio | 7.30 | 7.26 |
| Feed rate (cm²/s) | 1.12 | 1.12 |
| Power (mA) | 17.12 | 17.73 |
| Performance (%) | 100.0 | 99.4 |

FX analyses show that there is no significant difference in the composition between grains recycled using the method according to the invention and grains that have not been recycled.

Furthermore, comparative cutting tests show that performances of cutting disks fabricated from recycled corundum grains are similar to performances of grains fabricated from new corundums, and particularly the difference in G-ratios, defined as the ratio between the volume removed to the abrasive volume used is less than 1%.

### REFERENCES

[1] Patent application U.S. 2003/032384 in the name of Noritake Co., Limited published on Feb. 23, 2003;

[2] International application WO 96/20070 in the name of Schleifmittel-Werk Karl-Seiffert GmbH & Co. published on Jul. 4, 1996;

[3] International application WO 2011/092021 in the name of Gottfried Wilhem Leibniz Universitat Hannover published on Aug. 4, 2011;

1) Process for recovery of all or some abrasive elements from an abrasive material in which said abrasive elements are held in a resin with at least one phenolic hydroxyl group, said process including steps of:
a) bringing said abrasive material into contact with an aqueous nitric solution (S₁), whereby an aqueous nitric solution (S₂) is obtained containing abrasive elements and residue derived from degradation of said resin; then
b) separating the abrasive elements from the aqueous nitric solution (S₂) obtained subsequent to said step (a).

2) Process according to claim 1, characterised in that said resin is a phenoplast.

3) Process according to claim 1, characterised in that said abrasive elements are chosen from the group consisting of alumina, brown corundums, white corundums, violet corundums, zirconia, diamond, silicon carbide, sintered bauxite and mixtures thereof.

4) Process according to claim 1, characterised in that said aqueous nitric solution (S₁) contains at least 20% by mass of nitric acid relative to the total mass of said aqueous nitric solution (S₁).

5) Process according to claim 1, characterised in that said aqueous nitric solution (S₁) also contains sulphuric acid.

6) Process according to claim 5, characterised in that said aqueous nitric solution (S₁)contains at least 30% by mass of sulphuric acid relative to the total mass of said aqueous nitric solution (S₁).

7) Process according to claim 1, characterised in that during step (a), contact is made at a temperature comprised between ambient temperature and 150° C.

8) Process according to claim 1, characterised in that before step (a), a grinding or crushing type treatment is carried out on said abrasive material.

9) Process according to claim 1, characterised in that an additional recycling step is carried out on the nitric acid solution (S₂) obtained after said step (b).

10) Process for preparation of an abrasive material comprising abrasive elements in a binder, said process comprising the following steps of:
i) obtaining abrasive elements following a recovery process such as defined in claim 1;
ii) bringing the abrasive elements obtained in said step (i) into contact with a binder or a precursor of said binder and mixing the assembly;
iii) possibly applying a heat treatment to the mixture obtained after said step (ii).

11) Process for preparation of an abrasive material comprising abrasive elements on a support, said process comprising the following steps of:
i′) obtaining abrasive elements following a recovery process such as defined in claim 1;
ii′) depositing abrasive elements obtained after said step (i′) on a support with a layer of a first binder;
iii′) applying a layer of a second binder, identical to or different from said first binder, on the support obtained after said step (ii′).
